(19) United States
(12) Patent Application Publication
(10) Pub. No.: US 2017/0357902 A1
(43) Pub. Date: Dec. 14, 2017

(54) INFORMATION PROCESSING APPARATUS, INFORMATION PROCESSING SYSTEM, AND METHOD FOR PREDICTING AMOUNT OF USAGE

(71) Applicant: Akira NAGAMORI, Kanagawa (JP)

(72) Inventor: Akira NAGAMORI, Kanagawa (JP)

(73) Assignee: Ricoh Company, Ltd., Tokyo (JP)

(21) Appl. No.: 15/604,895

(22) Filed: May 25, 2017

(30) Foreign Application Priority Data
Jun. 10, 2016 (JP) 2016-116379

(51) Int. Cl. G06N 5/02

(52) U.S. Cl. CPC G06N 5/022

(57) ABSTRACT

An information processing apparatus includes circuitry to acquire information relating to an actual usage record of an output device in a customer environment, and predict an amount of usage of the output device for a predetermined period of time of a target year based on the acquired information. In predicting, the circuitry calculates an amount of usage of the output device for a year-ago predetermined period of time corresponding to the predetermined period of time of the target year, and predicts the amount of usage of the output device for the predetermined period of time of the target year as being equal to the calculated amount of usage of the output device for the-year ago predetermined period of time.

### CROSS-REFERENCE TO RELATED APPLICATIONS

This patent application is based on and claims priority pursuant to 35 U.S.C. §119(a) to Japanese Patent Application No. 2016-116379, filed on Jun. 10, 2016 in the Japan Patent Office, the entire disclosure of which is hereby incorporated by reference herein.

### BACKGROUND

### Technical Field

The present disclosure relates to an information processing apparatus, a method for predicting an amount of usage, and an information processing system.

### Description of the Related Art

An information management system has been already known that acquires device information from an electronic device in a customer environment and outputs a summary report based on the device information.

A typical information management system generates report data obtained by summarizing a usage status of the electronic device for a predetermined report period to output the summary report based on the device information acquired from the electronic device in the customer environment.

### SUMMARY

An information processing apparatus includes circuitry to acquire information relating to an actual usage record of an output device in a customer environment, and predict an amount of usage of the output device for a predetermined period of time of a target year based on the acquired information. In predicting, the circuitry calculates an amount of usage of the output device for a year-ago predetermined period of time corresponding to the predetermined period of time of the target year, and predicts the amount of usage of the output device for the predetermined period of time of the target year as being equal to the calculated amount of usage of the output device for the-year ago predetermined period of time.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 a schematic view illustrating an example configuration of an information processing system according to an embodiment of the present disclosure;

FIG. 2 is a block diagram illustrating an example hardware configuration of a computer according to an embodiment of the disclosure;

FIG. 3 is a block diagram illustrating an example hardware configuration of an output device according to an embodiment of the present disclosure;

FIG. 4 is a block diagram illustrating an example functional configuration of a counter storage apparatus according to according to an embodiment of the present disclosure;

FIG. 5 is a block diagram illustrating an example functional configuration of a web server apparatus according to an embodiment of the present disclosure;

FIG. 6 is an illustration of an example configuration of a counter setting according to an embodiment of the present disclosure;

FIG. 7 is an illustration of an example configuration of daily data according to an embodiment of the present disclosure;

FIG. 8 is an illustration of an example configuration of monthly data according to an embodiment of the present disclosure;

FIG. 9 is an illustration of an example configuration of customer information according to an embodiment of the present disclosure;

FIG. 10 is an illustration of an example configuration of device information according to an embodiment of the present disclosure;

FIG. 11 is a flowchart illustrating steps in an example operation of counter storage according to an embodiment of the present disclosure;

FIG. 12 is a sequence diagram illustrating an example operation of displaying a web page according to an embodiment of the present disclosure;

FIG. 13 is a flowchart illustrating steps in an example operation of prediction calculation according to an embodiment of the present disclosure;

FIG. 14 is an example graph illustrating progression of total counter values in the monthly data according to an embodiment of the present disclosure;

FIGS. 15A to 15C are an illustration of an example screen displaying a top page according to an embodiment of the present disclosure;

FIGS. 16A and 16B are an illustration of an example screen displaying a predicted amount of usage for each of a copier, a printer, and a facsimile according to an embodiment of the present disclosure;

FIGS. 17A and 17B are an illustration of an example screen displaying a predicted usage rate for each of a two-sided function, a collate function, a staple function and a reduce/enlarge function according to an embodiment of the present disclosure;

FIGS. 18A to 18C are an illustration of an example screen displaying prediction of a CO₂ emission amount and a reduction amount of CO₂ emission by a reduction of paper according to an embodiment of the present disclosure;

FIG. 19 is a flowchart illustrating steps in an example operation of prediction calculation according to another embodiment of the present disclosure;

FIG. 20 is an example graph illustrating progression of total counter values in the monthly data according to another embodiment of the present disclosure, and

FIG. 21 a schematic view illustrating an example configuration of the information processing system according to a still another embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Hereinafter, a description is given of several embodiments of the present disclosure with reference drawings.

### First Embodiment

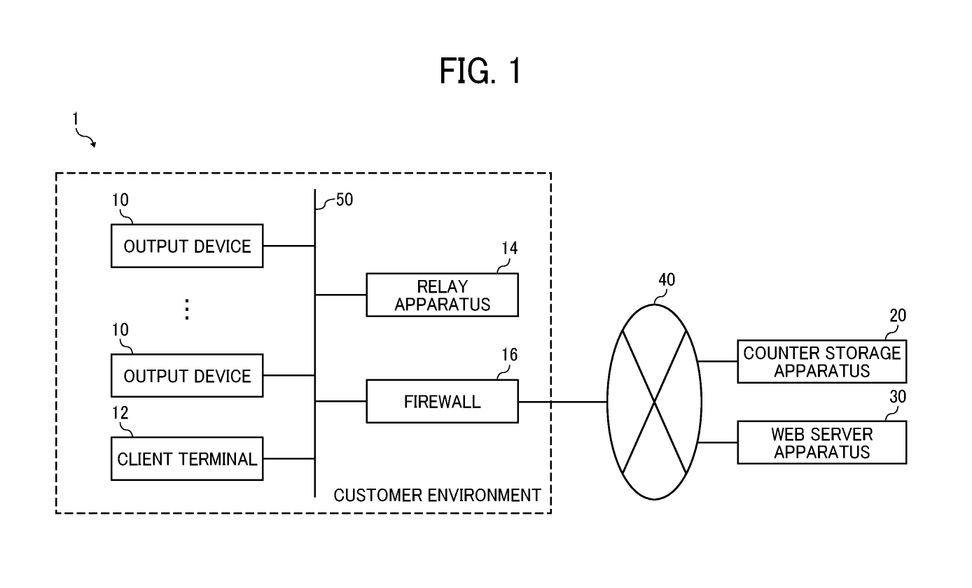

FIG. 1 a schematic view illustrating an example configuration of an information processing system 1 according to a first embodiment. In the information processing system 1 illustrated in FIG. 1, a customer environment is connected to a counter storage apparatus 20 and a web server apparatus 30 via a network 40 such as the Internet.

The customer environment is a network environment of a customer side. The customer may be either an individual user or an organization such as a company, a group, and a division. In the customer environment, at least one output device 10, a client terminal 12, a relay apparatus 14 and a firewall 16 are connected to one another via a network 50 such as a local area network (LAN).

Examples of the output device 10 include an image forming apparatus such as a laser printer and a multifunction peripheral (multifunctional printer), a projector, an electronic white board, a videoconference apparatus, a camera, industrial equipment having a communication capability, and medical equipment having a communication capability. The client terminal 12 is an information processing apparatus used by a user. Examples of the client terminal 12 include a smartphone, a mobile phone, a tablet personal computer (PC), a desktop PC, and a laptop computer. In the client terminal 12, an application having a screen displaying function is installed, such as a web browser.

The relay apparatus 14 collects, from each output device 10, information (a counter value) indicating an actual usage record of the output device 10, and sends the collected information to the counter storage apparatus 20. It should be noted that the output device 10 may send the counter value directly to the counter storage apparatus 20 without intervening the relay apparatus 14. The information processing system 1 may not include the relay apparatus 14.

The counter storage apparatus 20 stores the counter value of the output device 10 received from the customer environment. A detailed description is given later of storing the counter value by the counter storage apparatus 20. The web server apparatus 30 predicts an amount of usage of the output device 10 in the customer environment based on the counter value stored in the counter storage apparatus 20. The web server apparatus 30 generates screen data based on which the client terminal 12 displays information indicating the predicted amount of usage of the output device 10, and transmits the screen data to the client terminal 12.

It should be noted that the configuration of the information processing system 1 illustrated in FIG. 1 is just an example, and one or more server apparatus such as a proxy server and a gateway server may intervene between the customer environment and the counter storage apparatus 20. Further, the client terminal 12 may be outside the customer environment and may be connected to the network 40, for example. The counter storage apparatus 20 and the web server apparatus 30 could be implemented by a single information processing apparatus. Alternatively, the counter storage apparatus 20 and the web server apparatus 30 could be implemented by plural information processing apparatuses.

For example, a part or all of functions of the counter storage apparatus 20 may be performed by the web server apparatus 30 or any other suitable server apparatus. Further, a part or all of functions of the web server apparatus 30 may be performed by the counter storage apparatus 20 or any other suitable server apparatus.

As described heretofore, in the information processing system 1 according to the present embodiment, the counter storage apparatus 20 collects information indicating the actual usage record of the output device 10. The web server apparatus 30 predicts a future (e.g., next month or next year) amount of usage of the output device 10 in the customer environment based on the information indicating the actual usage record of the output device 10 collected in the counter storage apparatus 20. Further, the web server apparatus 30 generates a web page including, as information, the predicted amount of usage of the output device 10. The web browser installed in the client terminal 12 displays the web page.

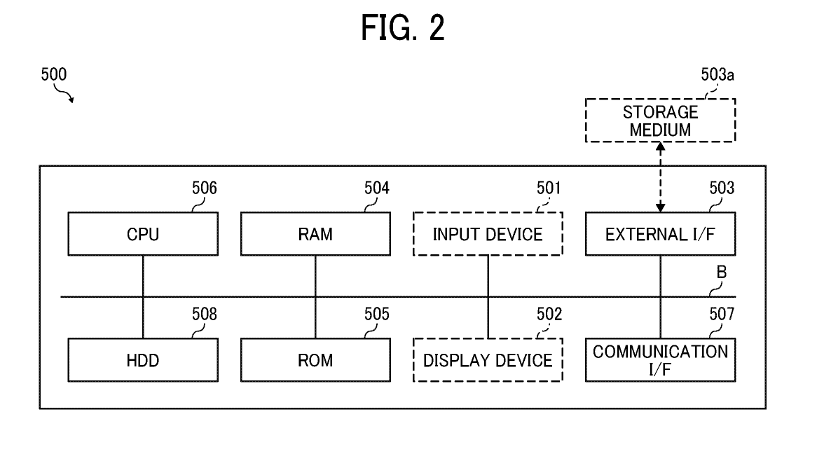

The client terminal 12 of FIG. 1 is implemented by a computer 500 having an example hardware configuration as illustrated in FIG. 2. Further, each of the one or more information processing apparatuses that implement the counter storage apparatus 20 and the web server apparatus 30 is also implemented by the computer 500 having an example hardware configuration as illustrated in FIG. 2.

FIG. 2 is a block diagram illustrating an example hardware configuration of the computer 500. As illustrated in FIG. 2, the computer 500 includes an input device 501, a display device 502, an external interface 503, a random access memory (RAM) 504, a read only memory (ROM) 505, a central processing unit (CPU) 506, a communication interface 507, and a hard disc drive (HDD) 508, which are connected to one another via a bus B. It should be noted that the input device 501 and the display device 502 are not necessarily constantly connected to the bus B. In other words, the input device 501 and the display device 502 could be connected to the bus B as necessary when used.

The input device 501 includes a keyboard, a mouse, and/or a touch panel enabling a user to input various operation instruction. The display device 502 includes a display on which results of processing by the computer 500 are displayed.

The communication interface 507 is an interface device to connect the computer 500 to various networks. The computer 500 performs data communication via the communication interface 507.

The HDD 508 is an example of a nonvolatile storage device that stores programs or data therein. Examples of the programs or data stored in the HDD 508 include an operating system (OS) as basic software for controlling an entire operation of the computer 500 and application software providing various functions on the OS. The application software may be referred to as an “application” hereinafter, in order to simplify description. The computer 500 may include, instead of the HDD 508, a drive device such as a solid state drive that uses a flash memory as a storage medium.

The external interface 503 is an interface device with an external device. Examples of the external device include a storage medium 503a. The external interface 503 enables the computer 500 to read or write data from or to the storage medium 503a. Examples of the storage medium 503a include a flexible disc, a compact disc (CD), a digital versatile disc (DVD), a SD memory card, and a universal serial bus (USB) memory.

The ROM 505 is an example of a nonvolatile semiconductor memory (storage device), which holds programs or data even after the computer 500 is turned off as the power is not supplied. The ROM 505 stores programs and data such as a basic input output system (BIOS), which is executed when the computer 500 starts up, OS settings, and network settings. The RAM 504 is a volatile semiconductor memory (storage device), which holds programs or data temporarily.

The CPU 506 reads programs or data from a storage device such as the ROM 505 and the HDD 508 onto the RAM 504, and executes processing to implement the entire control of the computer 500 or functions of the computer 500.

The client terminal 12, the counter storage apparatus 20, and the web server apparatus 30 implement various processing as described later with the example hardware configuration of the computer 500 as illustrated in FIG. 2.

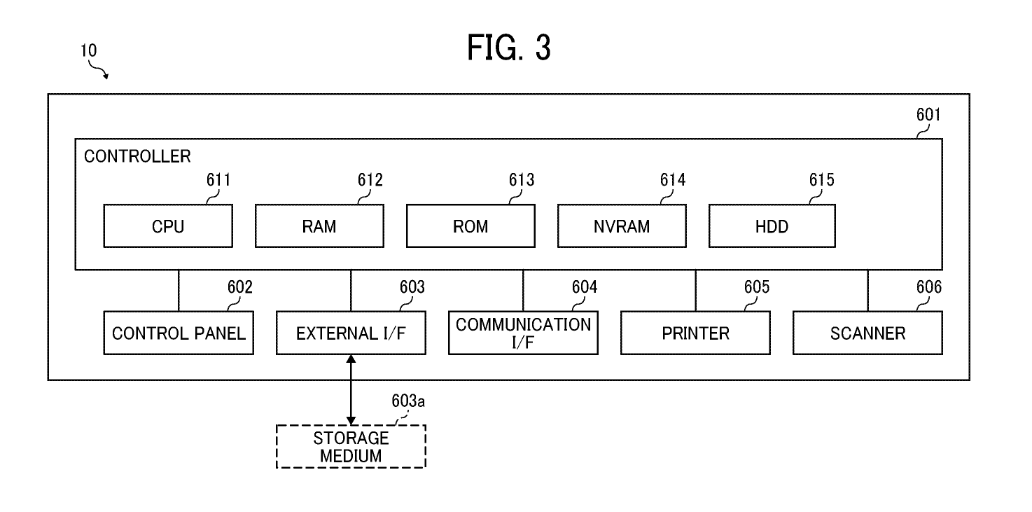

In a case in which the output device 10 of FIG. 1 is a multifunction peripheral, the output device 10 is implemented by a computer having an example hardware configuration as illustrated in FIG. 3. FIG. 3 is a block diagram illustrating an example hardware configuration of the output device 10. As illustrated in FIG. 3, the output device 10 includes a controller 601, a control panel 602, an external interface 603, a communication interface 604, a printer 605, and a scanner 606.

The controller 601 includes a CPU 611, a RAM 612, a ROM 613, a non-volatile random access memory (NVRAM) 614, and an HDD 615. The ROM 613 stores various programs and data. The RAM 612 stores programs and data temporarily. The NVRAM 614 stores setting information, etc., for example. The HDD 615 stores various programs and data.

The CPU 611 performs processing according to the programs, data, setting information, etc., read from the ROM 613, the NVRAM 614, the HDD 615, etc., onto the RAM 612 to implement the entire control of the output device 10 or functions of the output device 10.

The control panel 602 includes an input unit that accepts a user input, and a display unit that displays various types of information. The external interface 603 is an interface device with an external device. Examples of the external device include a storage medium 603a. The external interface 603 enables the output device 10 to read or write data from or to the storage medium 603a. Examples of the storage medium 603a include an integrated circuit (IC) card, a flexible disc, a CD, a DVD, a SD memory card, and a USB memory.

The communication interface 604 is an interface device to connect the output device 10 to the network 50. The output device 10 performs data communication via the communication interface 604. The printer 605 is a printing device that forms an image on a transferred medium in accordance with print data. Examples of the transferred medium include paper, coated paper, thick paper, overhead projector (OHP) transparencies, plastic films, pre-preg, and copper foil. The scanner 606 is a reading device that scans a document to obtain image data (electronic data).

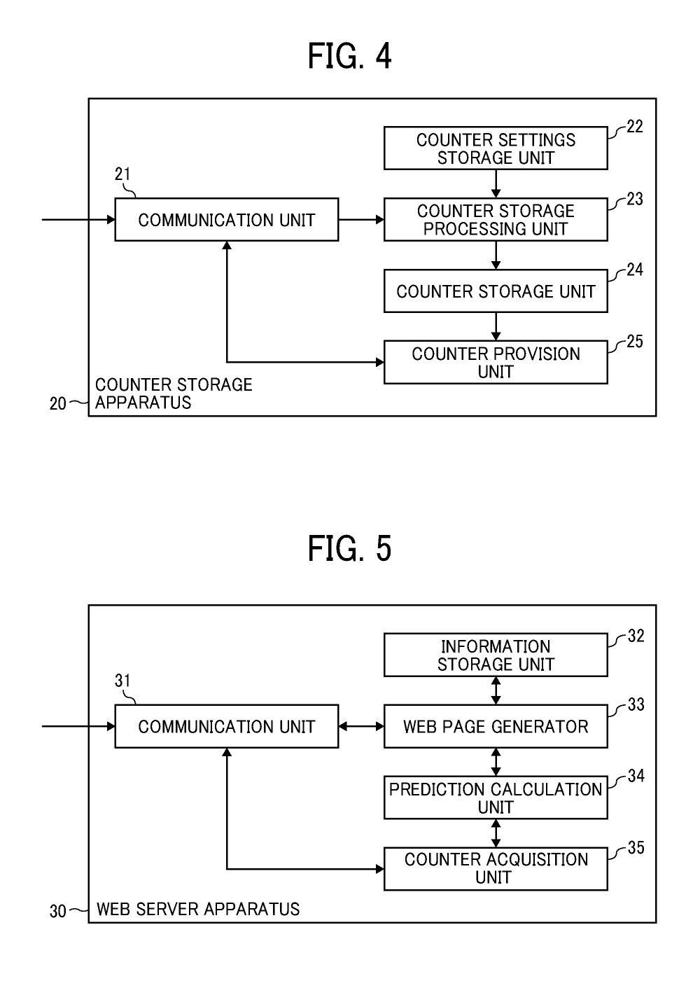

The counter storage apparatus 20 according to the first embodiment is implemented by processing blocks as illustrated in FIG. 4, for example. FIG. 4 is a block diagram illustrating an example functional configuration of the counter storage apparatus 20 according to the present embodiment. Each of the functional blocks of the counter storage apparatus 20 illustrated in FIG. 4 is implemented by the one or more programs stored in the HDD 508 or the ROM 505, which operate in cooperation with hardware as illustrated in FIG. 2.

As illustrated in FIG. 4, the counter storage apparatus 20 includes a communication unit 21, a counter settings storage unit 22, a counter storage processing unit 23, a counter storage unit 24, and a counter provision unit 25. The communication unit 21 performs data communication with the outside. For example, the communication unit 21 communicates data with the output device 10 and the relay apparatus 14.

The counter settings storage unit 22 stores a counter setting, which is described later. The counter setting is information based on which the counter storage processing unit 23 stores a counter value. Based on the counter setting, the counter storage processing unit 23 stores, in the counter storage unit 24, daily data and monthly data for each output device 10. It should be noted that the counter storage processing unit 23 may store, in the counter storage unit 24, daily data and monthly data for each customer environment.

The counter storage unit 24 stores, in the counter storage unit 24, the daily data and the monthly data for each the output device 10. The counter storage unit 24 may store the daily data and the monthly data for each customer environment. In response to a request from the web server apparatus 30, the counter provision unit 25 provides the web server apparatus 30 with the daily data and the monthly data of each output device 10 stored in the counter storage unit 24. Further, in response to a request from the web server apparatus 30, the counter provision unit 25 may provide the web server apparatus 30 with the daily data and the monthly data of each customer environment stored in the counter storage unit 24.

The web server apparatus 30 according to the first embodiment is implemented by processing blocks as illustrated in FIG. 5, for example. FIG. 5 is a block diagram illustrating an example functional configuration of the web server apparatus 30 according to the present embodiment. The functional blocks of the web server apparatus 30 as illustrated in FIG. 5 are implemented by the one or more programs stored in the HDD 508 or the ROM 505, which operate in cooperation with hardware as illustrated in FIG. 2.

As illustrated in FIG. 5, the web server apparatus 30 includes a communication unit 31, an information storage unit 32, a web page generator 33, a prediction calculation unit 34, and a counter acquisition unit 35. The communication unit 31 performs data communication with the outside. For example, the communication unit 31 communicates data with the client terminal 12 and the counter storage apparatus 20.

The information storage unit 32 stores customer information and device information, which are described later. The customer information and the device information are information based on which the web server apparatus 30 generates a web page to be displayed at the client terminal 12. The customer information and the device information enable identification of the output device 10 placed in customer environment, and identification of the daily data and the monthly data of the identified output device 10.

In response to a request from the client terminal 12, the web page generator 33 generates a web page and causes the web browser installed in the client terminal 12 to display the web page. Further, in a case in which the prediction of the amount of future usage of the output device 10 in the customer environment is required for the generation of the web page, the web page generator 33 specifies the customer environment and requests the prediction calculation unit 34 to predict the amount of usage.

The prediction calculation unit 34 specifies the output device 10 in the customer environment for which the prediction of the amount of usage is to be performed, and predicts the amount of future usage based on the monthly data of the specified output device 10 as described later. The prediction calculation unit 34 requests and acquires the daily data or the monthly data of the output device 10 in the customer environment from the counter acquisition unit 35.

Specifically, the prediction calculation unit 34 performs prediction of a total amount of usage in the customer environment, prediction of the amount of usage of the output device 10 for each of multiple functions, prediction of the amount of usage for each of multiple page sizes, prediction of power consumption or CO₂ emission amount, depending on the web page to be generated. For example, the prediction calculation unit 34 predicts the amount of usage for each of multiple functions of the output device 10 such as a copier function, a printer function, and a facsimile function of a multifunction peripheral. In addition, for example, the prediction calculation unit 34 predicts the amount of usage for each of multiple editing functions and each of multiple finishing functions such as a color printing, a monochrome printing, a two-sided printing and a pages-per-sheet printing.

The counter acquisition unit 35 acquires, from the counter storage apparatus 20, the daily data or the monthly data of the output device 10 in the customer environment requested by the prediction calculation unit 34. Further, the counter acquisition unit 35 provides the prediction calculation unit 34 with the acquired daily data or monthly data.

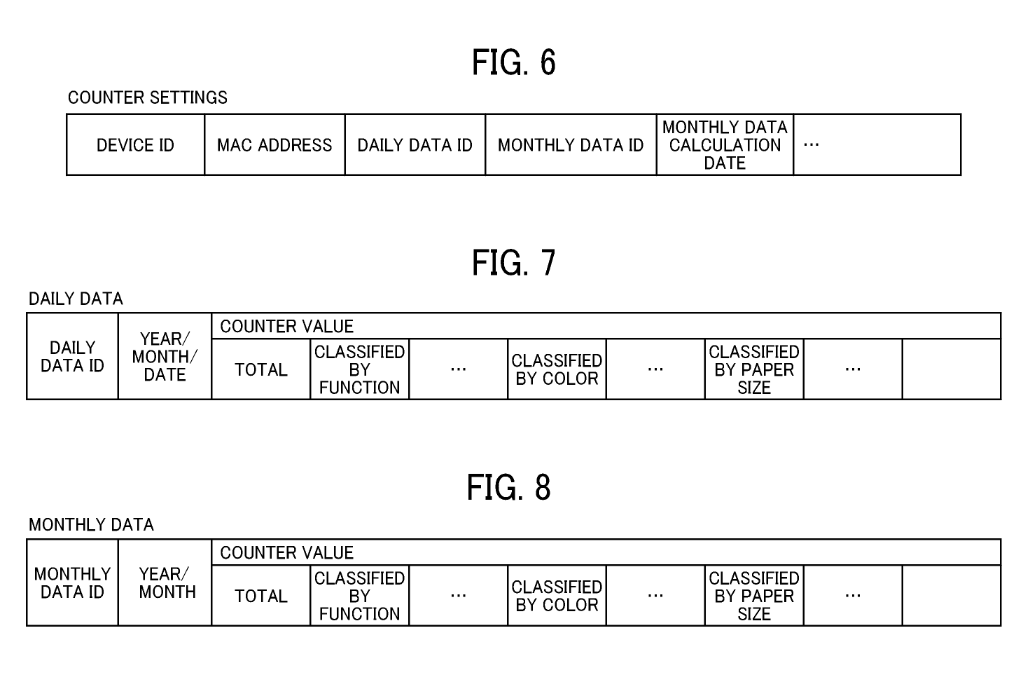

FIG. 6 is an illustration of an example configuration of the counter setting. The counter setting includes, as items, a device ID, a MAC address, a daily data ID, a monthly data ID, and a monthly data calculation date. The device ID is an example of identification information for identifying the output device 10. The MAC address is an example of identification information for identifying the output device 10 on a communication network. The daily data ID is an example of identification information for identifying daily data of the output device 10 specified by the device ID or the MAC address. The monthly data ID is an example of identification information for identifying monthly data of the output device 10 specified by the device ID or the MAC address. The monthly data calculation date indicates a calculation date necessary for generating the monthly data for the customer, for example.

FIG. 7 is an illustration of an example configuration of the daily data. The daily data includes, as items, a daily data ID, a date (year/month/date), and various counter values. The daily data ID is an example of identification information for identifying daily data. The date is a date on which the counter values of the corresponding daily data is counted. The various counter values are daily counter values of different types such as a total, for each function, for each color, and for each paper size.

FIG. 8 is an illustration of an example configuration of the monthly data. The monthly data includes, as items, a monthly data ID, a date (year/month/date), and various counter values. The monthly data ID is an example of identification information for identifying monthly data. The date is a date on which the counter values of the corresponding monthly data is counted. The various counter values are monthly counter values of different types such as a total, for each function, for each color, and for each paper size.

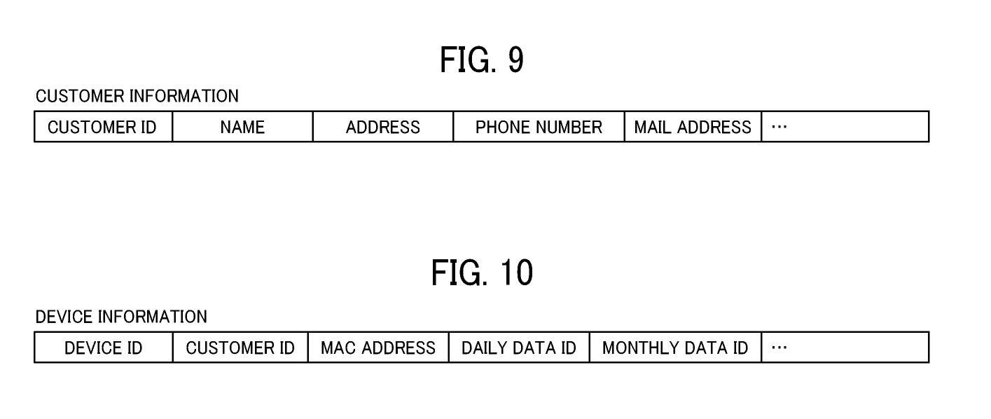

FIG. 9 is an illustration of an example configuration of the customer information. The customer information includes, as items, a customer ID, a name, an address, a phone number, and a mail address. The customer ID is an example of identification information for identifying a customer. The name, the address, the phone number, and the address are respectively a customer's name, a customer's address, a customer's phone number, and a customer's mail address. The customer information is used, for example, for displaying the customer's name, address, phone number and mail address on the web page.

FIG. 10 is an illustration of an example configuration of the device information. The device information includes, as items, the device ID, the customer ID, the MAC address, the daily data ID, and the monthly data ID. With the use of device information that associates the customer ID with the device ID and the MAC address, the customer environment can be associated with the output device 10 in the customer environment.

Further, with the use of device information that associates the customer ID with the daily data ID and the monthly data ID, the customer can be associated with the daily data and the monthly data of the customer. Furthermore, with the use of device information that associates the device ID and the MAC address with the daily data ID and the monthly data ID, the output device 10 can be associated with the daily data and the monthly data of the output device 10.

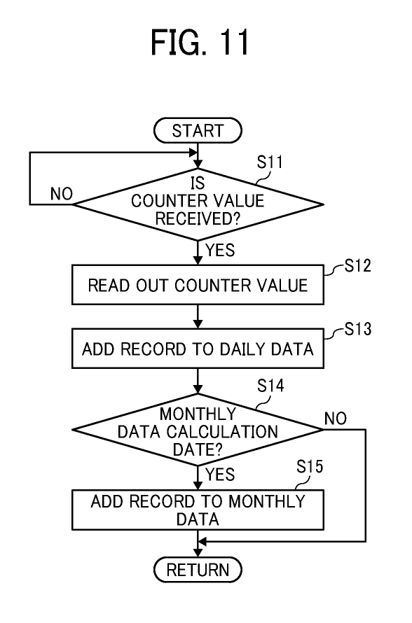

The counter storage apparatus 20 of the information processing system 1 according to the present embodiment performs a counter storage process with an operation illustrated in FIG. 11, for example. FIG. 11 is a flowchart illustrating steps in the counter storage process.

At S11, the counter storage processing unit 23 of the counter storage apparatus 20 waits until a counter value is received from the output device 10 or the relay apparatus 14 in the customer environment. In response to receiving the counter value, at S12, the counter storage processing unit 23 of the counter storage apparatus 20 reads out the counter setting of FIG. 6 from the counter settings storage unit 22.

At S13, based on the counter setting that is read out at S12, the counter storage processing unit 23 adds the daily data ID to the received counter value to generate a record of the daily data. Further, the counter storage processing unit 23 stores the generated record of the daily data in the counter storage unit 24.

At S14, based on the counter setting that is read out at S12, the counter storage processing unit 23 determines whether the current time has passed the monthly data calculation date. In a case in which the current time is before the monthly data calculation date, the counter storage processing unit 23 skips a process of S15, and the operation returns to S11.

In a case in which the current time has passed the monthly data calculation date, the operation proceeds to S15. At S15, the counter storage processing unit 23 generates the monthly data based on the daily data for one month. Further, the counter storage processing unit 23 stores a record of the generated monthly data in the counter storage unit 24.

In the above, with reference to the flowchart of FIG. 11, a description is given of an example, not limited thereto, in which after the storage of the record of the daily data in the counter storage unit 24, the monthly data is generated based on the daily data if the current time has passed the monthly data calculation date of the customer. Alternatively, the counter storage processing unit 23 may generate the monthly data based on the daily data at the timing when the counter storage processing unit 23 receives a request for the monthly data from the web server apparatus 30. Further, the counter storage processing unit 23 may generate weekly data instead of the monthly data.

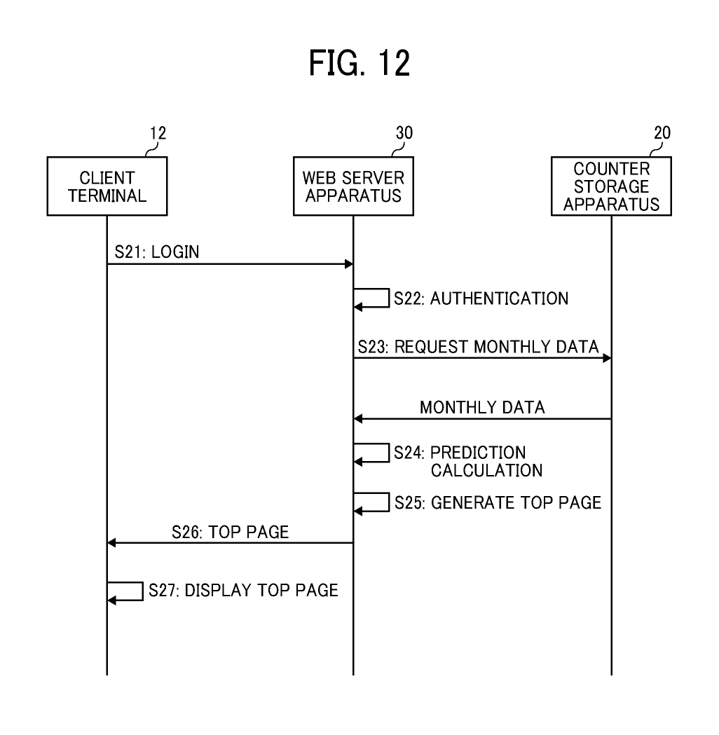

The information processing system 1 according to the present embodiment performs a web page display process with an operation illustrated in FIG. 12, for example. FIG. 12 is a sequence diagram illustrating an example operation of displaying the web page.

At S21, the web server apparatus 30 accepts a request for login from the client terminal 12 according to an instruction given from a user such as an administrator of the customer environment, for example. At S22, the web server apparatus 30 authenticates the user who requests the login. FIG. 12 illustrates an example in which the authentication is successful. It should be noted that in which the authentication is failed, the operation does not proceed to S23 and subsequent steps.

At S23, the counter acquisition unit 35 of the web server apparatus 30 acquires, from the counter storage apparatus 20, the monthly data associated with the customer ID. At S24, the prediction calculation unit 34 of the web server apparatus 30 predicts the amount of future usage (e.g., for next month) based on the monthly data of past 12 months associated with the customer ID. A detailed description is given later of the prediction at S24. The following description is given assuming that the prediction calculation unit 34 predicts, at S24, the total amount of usage in the customer environment.

At S25, the web page generator 33 of the web server apparatus 30 generates screen data of a top page containing the prediction of the total amount of usage (predicted amount of usage) in the customer environment calculated by the prediction calculation unit 34. A detailed description is given later of the top page. At S26, the web server apparatus 30 transmits the screen data of the top page to the client terminal 12. At S27, the web browser of the client terminal 12 that has received the screen data displays the top page containing the predicted total amount of usage in the customer environment.

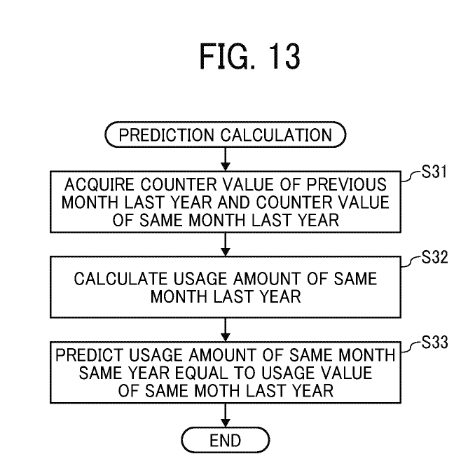

FIG. 13 is a flowchart illustrating steps in an example operation of the prediction calculation at S24. At S31, the prediction calculation unit 34 of the web server apparatus 30 calculates the monthly data of the total amount of usage in the user environment based on the monthly data of the customer environment acquired from the counter storage apparatus 20. The prediction calculation unit 34 acquires a counter value of the previous month last year and a counter value of the same month last year based on the calculated monthly data of the total amount of usage in the customer environment.

At S32, the prediction calculation unit 34 subtracts the counter value of the previous month last year acquired at S31 from the counter value of the same month last year acquired at S31 to obtain an amount of usage of the same month last year. At S33, the prediction calculation unit 34 predicts an amount of usage of the same month (next month) same year as being equal to the amount of usage of the same month last year calculated at S32.

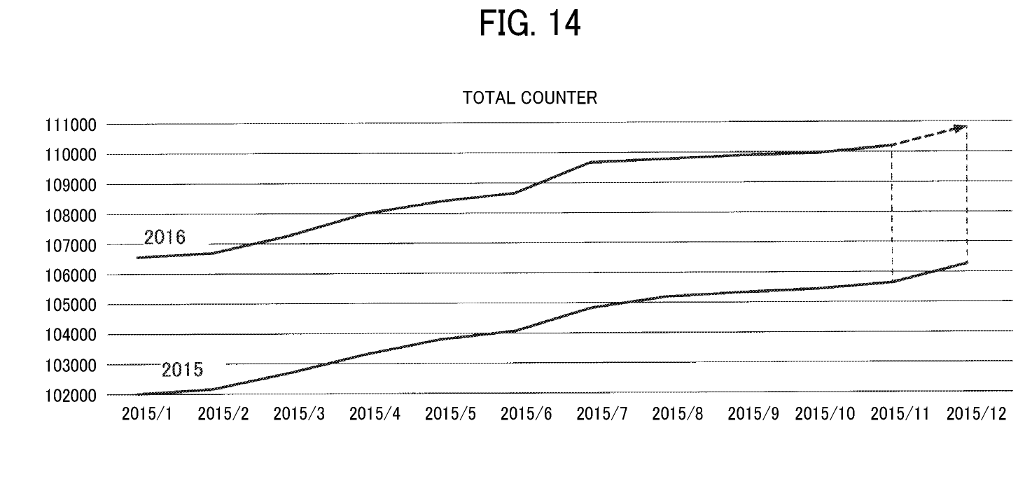

A description is given of a concept of the operation of the prediction calculation illustrated in FIG. 13 with reference to a graph of FIG. 14. FIG. 14 is an example graph illustrating progression of the total counter values for in the monthly data. FIG. 14 illustrates graphs of the year 2015 (last year) and the year 2016 (same year).

For example, in the case of a customer having busy times in business, the counter value tends to increase in substantially the same manner regardless of year, as illustrated in FIG. 14. Accordingly, the prediction calculation unit 34 predicts that the amount of usage of the same month same year is approximately equal to the amount of usage of the same month last year.

Although FIG. 13 illustrates the total counter value as an example, the amount of usage for each of multiple functions of the output device 10, the amount of usage for each of the multiple page sizes, the power consumption, and the CO₂ emission amount are predicted in substantially the same manner.

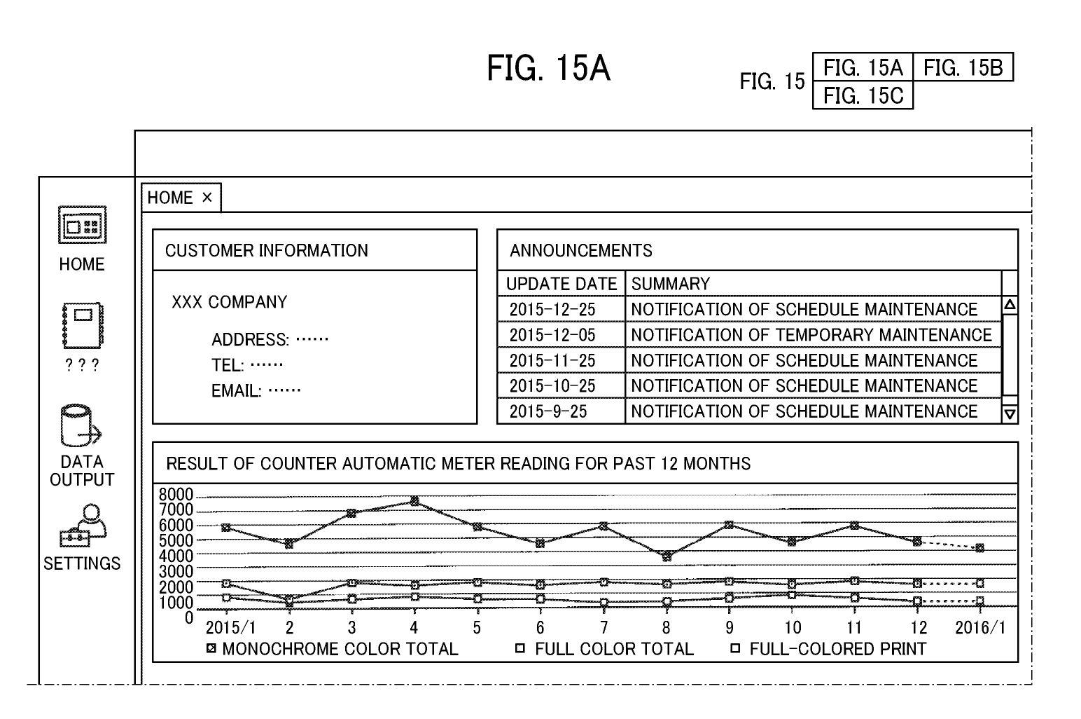

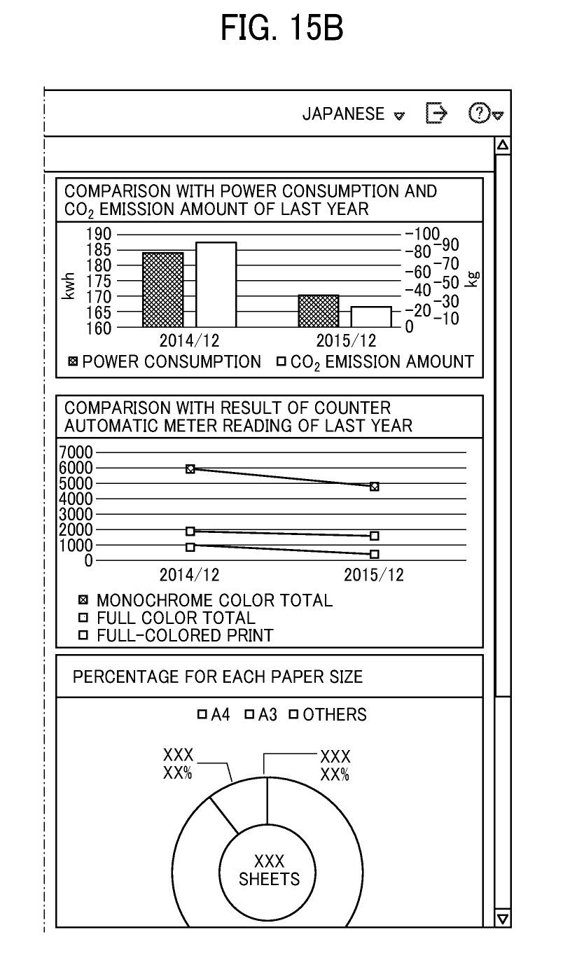

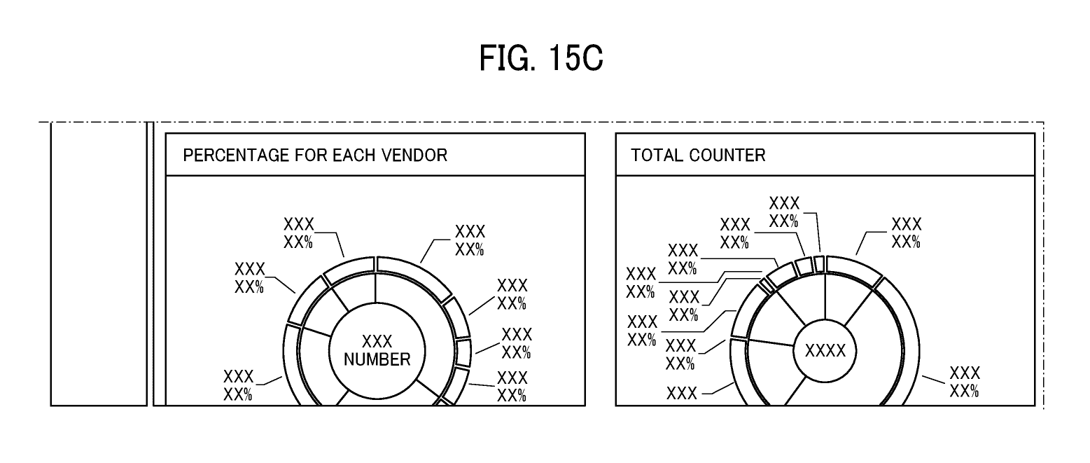

FIGS. 15A to 15C are an illustration of an example screen displaying the top page. In the top page of FIGS. 15A to 15C, the predicted amount of usage of the same month (next month) same year is indicated by a dotted line on the right side of “RESULT OF COUNTER AUTOMATIC METER READING FOR PAST 12 MONTHS” area. It should be noted that FIGS. 15A to 15C illustrates an example in which the counter values of a mono-color total, a full-color total, and a full-color print are displayed in the “RESULT OF COUNTER AUTOMATIC METER READING FOR PAST 12 MONTHS” area. In addition, “CUSTOMER INFORMATION” area in the upper left portion of the top page of FIGS. 15A to 15C is displayed by using the customer information of FIG. 9.

The user refers to the top page of FIGS. 15A to 15C displayed at the client terminal 12 to recognize a predicted amount of future usage (e.g., for next month) of the output device 10 in a customer environment, which is predicted based on the actual usage record of the output device 10 in the customer environment. The user is able to predict a charge based on the predicted amount of usage for next month. This makes it easy for the user to prepare a budget.

FIGS. 15A to 15C illustrate an example, not limited thereto, in which the prediction of the counter values of a mono-color total, a full-color total, and a full-color print are displayed on the tope page. In addition, a predicted amount of usage for each of multiple functions of the output device 10 or for each of multiple paper sizes can be displayed in substantially the same manner.

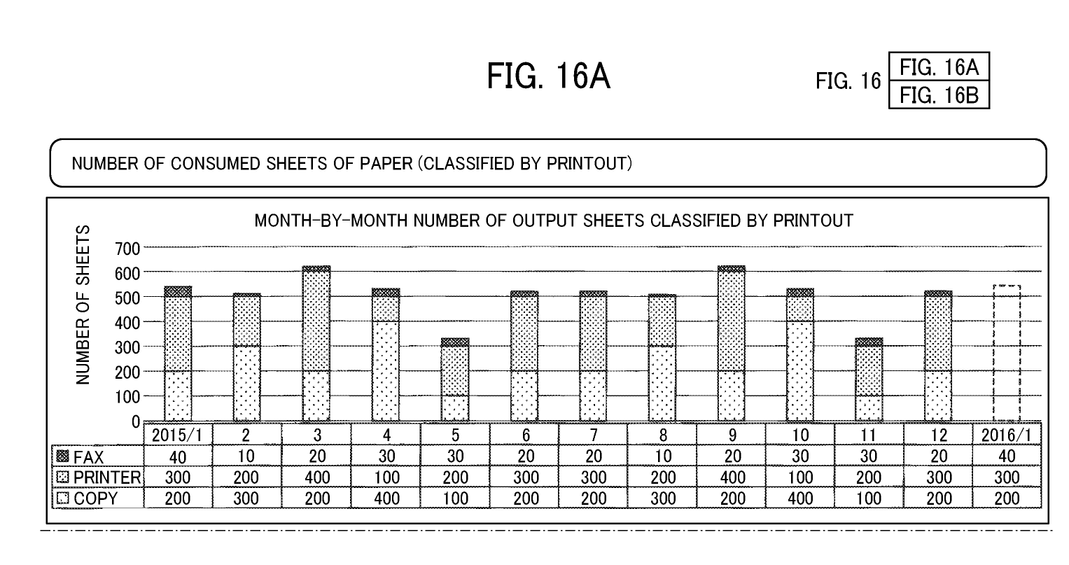

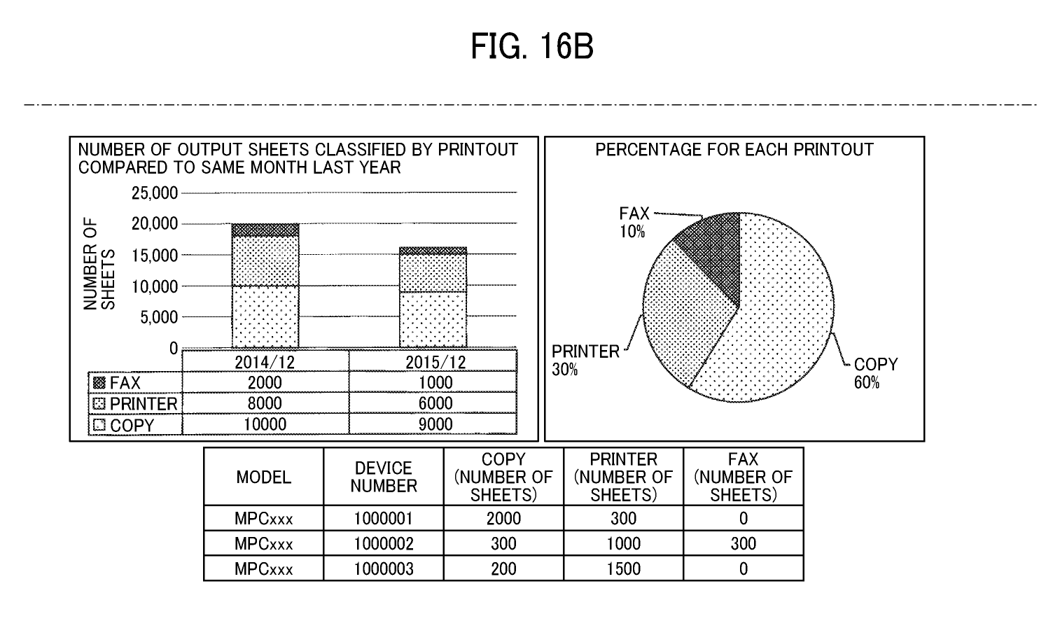

FIGS. 16A and 16B are an illustration of an example screen displaying a predicted amount of usage for each of a copier, a printer, and a facsimile. In the example screen of FIGS. 16A and 16B, a predicted amount of usage of the next month (January) is indicated by a dotted line on the right side of “MONTH-BY-MONTH NUMBER OF OUTPUT SHEETS CLASSIFIED BY PRINTOUT” area.

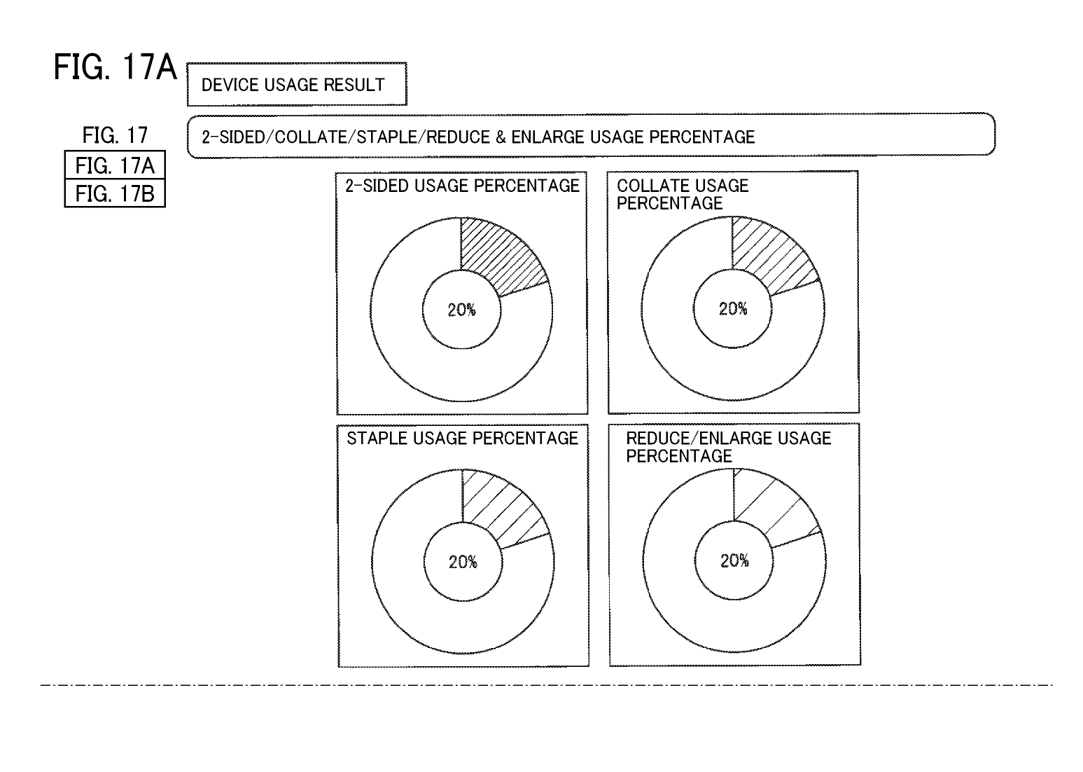

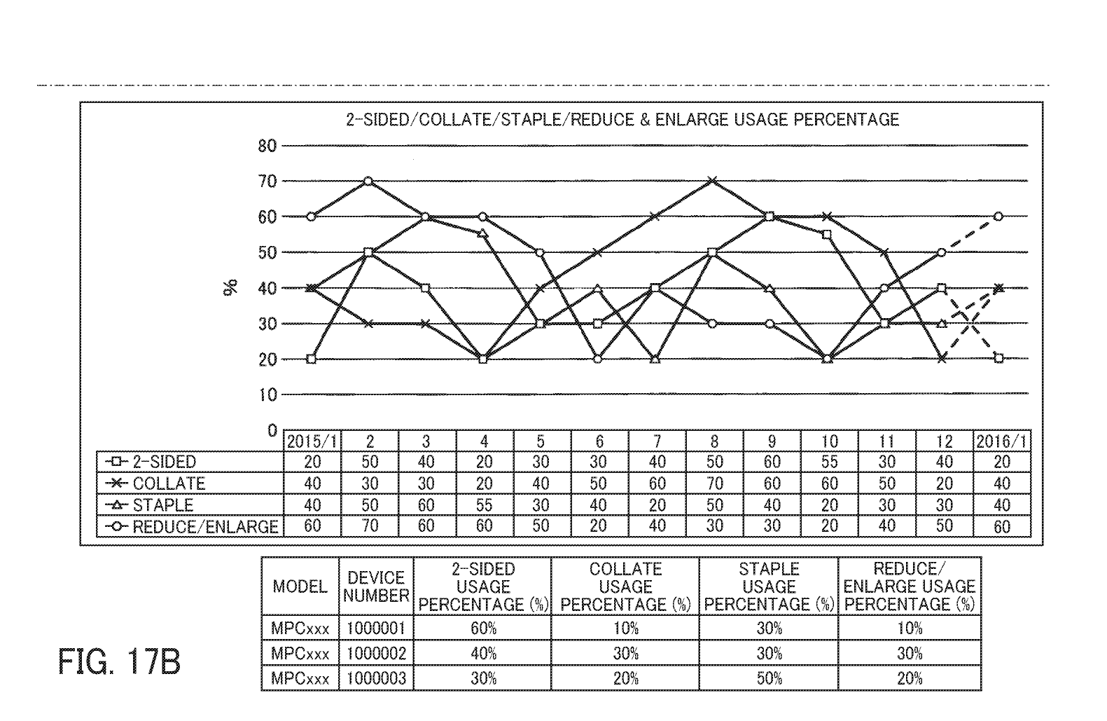

FIGS. 17A and 17B are an illustration of an example screen displaying a predicted usage rate for each of a two-sided function, a collate function, a staple function and a reduce/enlarge function. In the example screen of FIGS. 17A and 17B, the predicted usage rates of the next month (January) are indicated by dotted lines on the right side of “2-SIDED/COLLATE/STAPLE/REDUCE & ENLARGE USAGE PERCENTAGE” area.

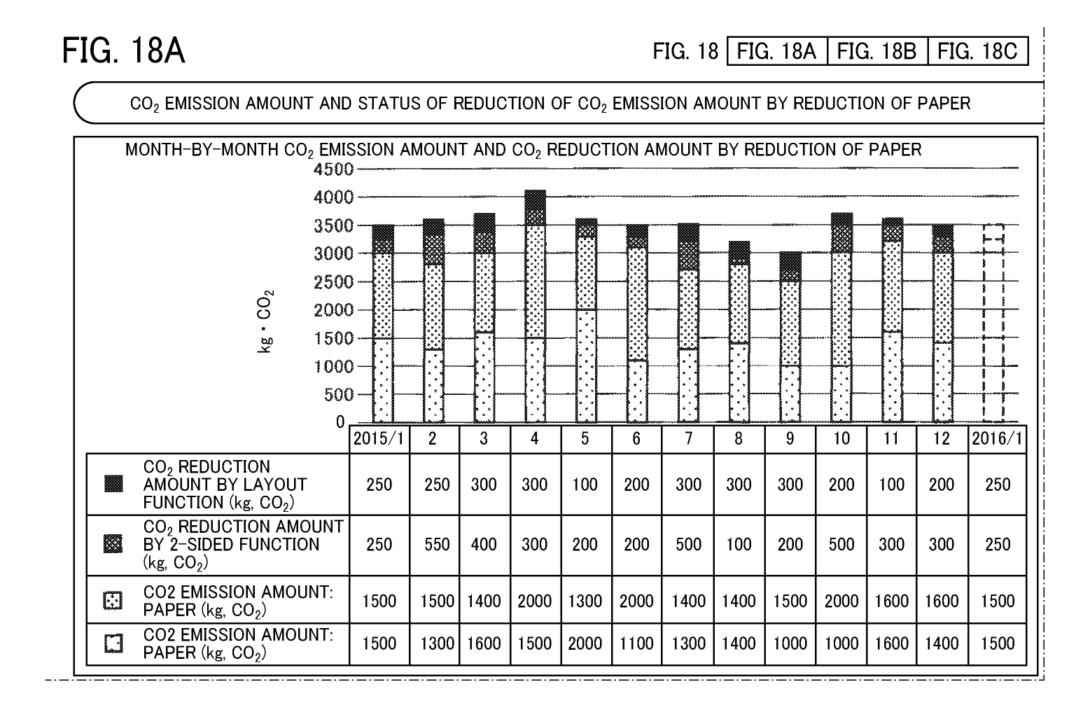

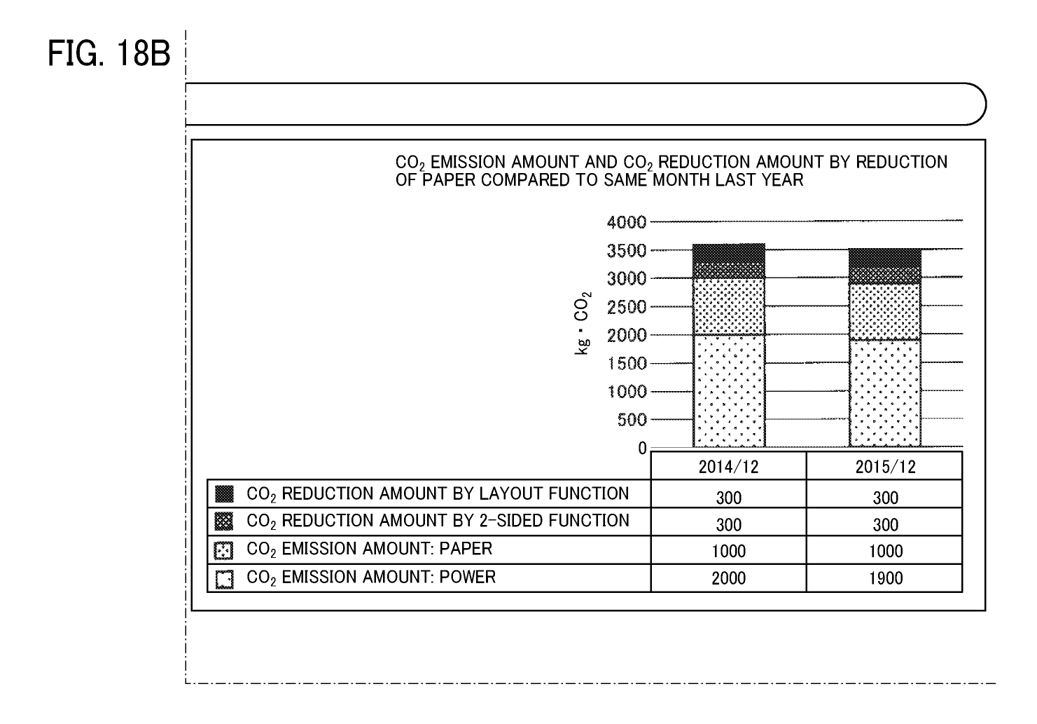

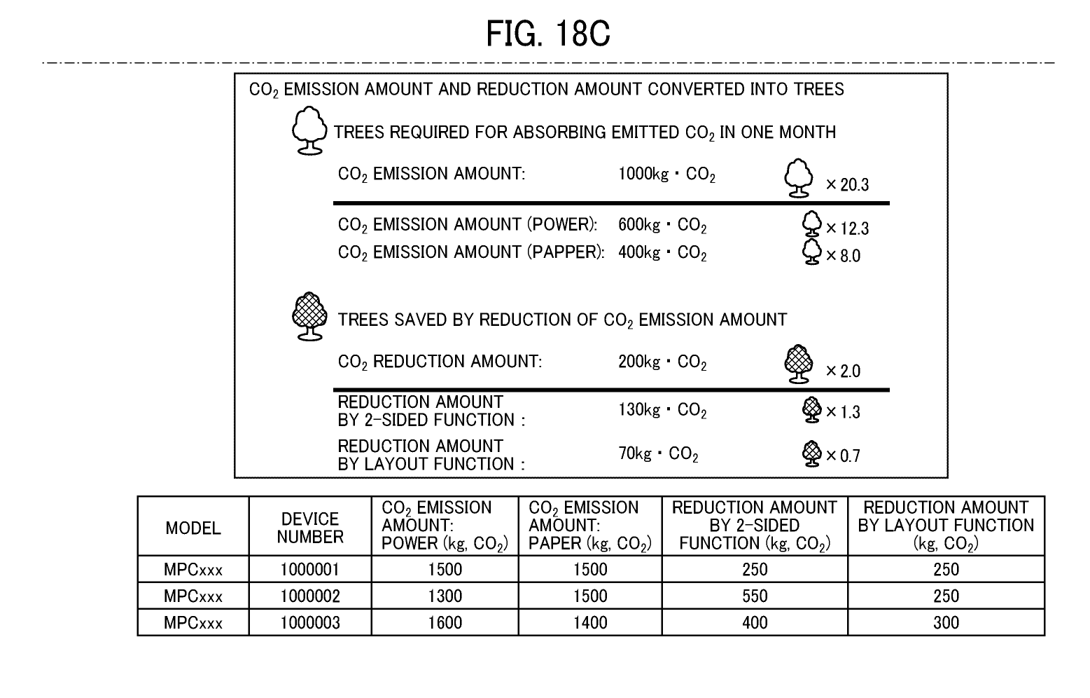

FIGS. 18A to 18C are an illustration of an example screen displaying prediction of a CO₂ emission amount and a reduction amount of CO₂ emission by a reduction of paper. In the example screen of FIGS. 18A to 18C, a predicted amount of CO₂ emission and a predicted reduction amount of CO₂ emission by reduction of paper of the next month (January) is indicated by a dotted line on the right side of “MONTH-BY-MONTH CO₂ EMISSION AMOUNT AND CO₂ REDUCTION AMOUNT BY REDUCTION OF PAPER” area.

As described heretofore, the information processing system 1 according to the first embodiment is able to predict that the amount of usage of the same month (next month) same year is approximately equal to the amount of usage of the same month last year and display the predicted amount of usage to a user. A description is given of an example in which the prediction calculation at S24 in the sequence diagram of FIG. 12 is performed at the timing when the user logs in the web server apparatus 30. Alternatively, the prediction calculation at S24 may be performed at the timing when the monthly data is generated or the timing when a user gives an instruction for the prediction calculation.

### Second Embodiment

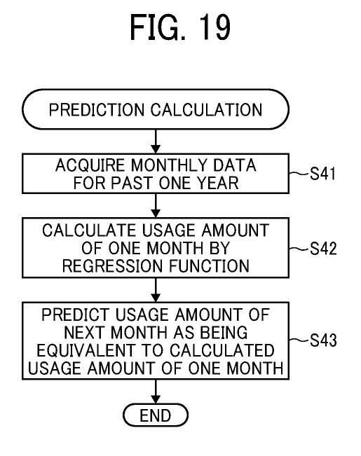

The prediction calculation at S24 of FIG. 12 is also implemented by an operation illustrated in FIG. 19, for example. FIG. 19 is a flowchart illustrating steps in another example operation of the prediction calculation at S24.

At S41, the prediction calculation unit 34 of the web server apparatus 30 calculates the monthly data of the total amount of usage in the customer environment based on the monthly data of the user environment acquired from the counter storage apparatus 20. The prediction calculation unit 34 acquires the monthly data of the total amount of usage for past one year in the customer environment.

At S42, the prediction calculation unit 34 calculates the amount of usage for one month with a regression function or the like. At S43, the prediction calculation unit 34 predicts an amount of usage of the next month as being equal to the amount of usage for one month calculated at S42.

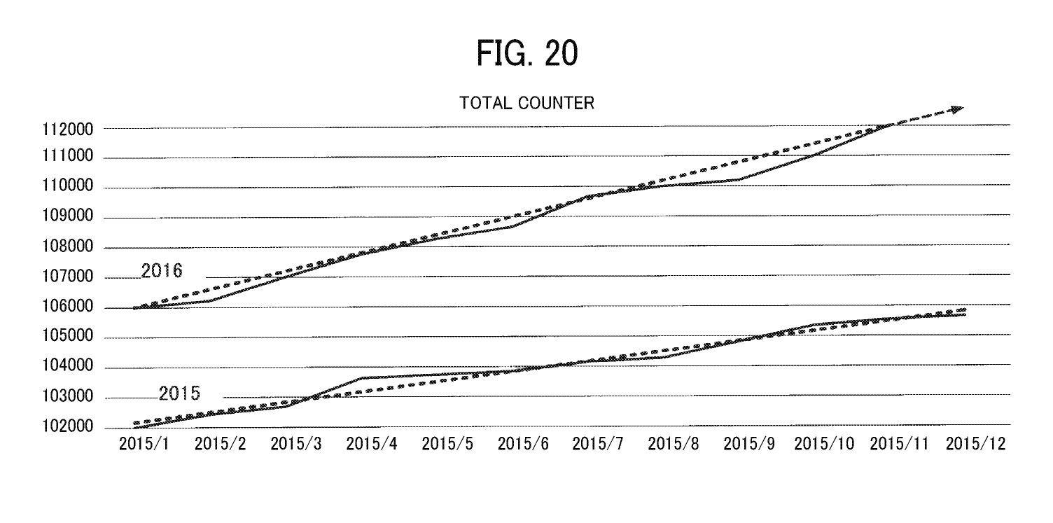

A description is given of a concept of the operation of the prediction calculation illustrated in FIG. 19 with reference to a graph of FIG. 20. FIG. 20 is an example graph illustrating progression of the counter values for the total in the monthly data. FIG. 20 illustrates graphs of the year 2015 (last year) and the year 2016 (same year).

For example, in the case of a customer that is undergoing downsizing or upsizing, the counter value could increase in a different manner from last year. Accordingly, the prediction calculation unit 34 obtains a slope of a regression line representing an annual amount of usage by using a regression function or the like to predict the amount of usage for next month based on the slope of the annual amount of usage. Thus, the information processing system 1 according to the second embodiment is able to predict the amount of usage in accordance with the expansion or reduction of their business volume.

The prediction calculation at S24 of FIG. 12 may be implemented by the combination of the operation illustrated in FIG. 13 and the operation illustrated FIG. 19. The combination of the operation illustrated in FIG. 13 and the operation illustrated FIG. 19 enables the information processing system 1 according to the second embodiment to predict the amount of usage in accordance with both the trends in increase of the counter value in the busy times and the expansion or reduction of the customer's business volume.

### Third Embodiment

In the information processing system 1 of FIG. 1, the counter storage apparatus 20 and the web server apparatus 30 are connected to the network 40 such as the Internet, which is outside of the customer environment. In other words, in the information processing system 1 of FIG. 1, the counter storage apparatus 20 and the web server apparatus 30 are provided in a so-called cloud environment.

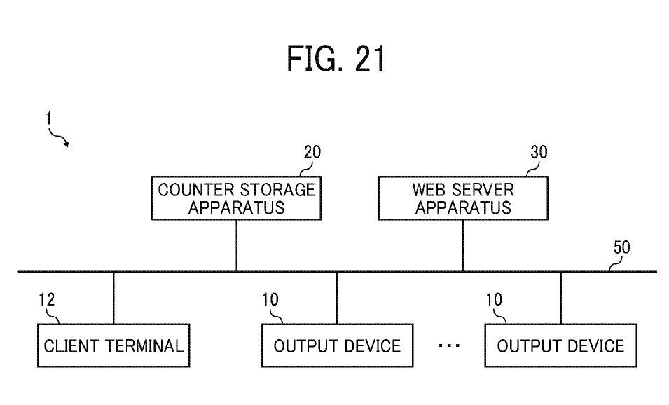

Alternatively, as illustrated in FIG. 21, the counter storage apparatus 20 and the web server apparatus 30 may be provided inside the customer environment (in an on-premises environment). FIG. 21 a schematic view illustrating an example configuration of the information processing system 1 according to a third embodiment. In the information processing system 1 illustrated in FIG. 21, at least one output device 10, the client terminal 12, the counter storage apparatus 20, and the web server apparatus 30 are connected to one another via the network 50 of the customer environment. The hardware configuration, the software configuration, and the operation of the information processing system 1 illustrated in FIG. 21 is substantially the similar to those of the information processing system 1 of FIG. 1, and the descriptions thereof are omitted.

By contrast, as described heretofore, the information processing system 1 according to the embodiments of the present disclosure is able to predict an amount of future usage of the output device 10 in the customer environment based on an actual usage record of the output device 10 in the customer environment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The counter storage apparatus 20 and the web server apparatus 30 are examples of an information processing apparatus described in the appended claims. The counter value is an example of information relating to an actual usage record of an output device described in the appended claims.

The same month same year is an example of a predetermined period of time of a target year described in the appended claims. The same month last year is an example of a year-ago predetermined period of time described in the appended claims. The past one year is an example of another period of time that is longer than the year-ago predetermined period of time described in the appended claims.

An amount of usage described in the appended claims is not limited to the counter value. The amount of usage described in the appended claims includes a period of time during which the output device 10 is used, a data amount or a number of images captured by the output device 10, an amount of data communication of the output device 10, a period of time during which the output device 10 outputs data, and an amount of data output from the output device 10.

The information processing system 1 described in the above embodiments is just an example, and there may be various system configurations depending on applications or purposes.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The CPU may be implemented by one or more processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information processing apparatus comprising:
circuitry to:
acquire information relating to an actual usage record of an output device in a customer environment; and
predict an amount of usage of the output device for a predetermined period of time of a target year based on the acquired information,
wherein, in predicting, the circuitry calculates an amount of usage of the output device for a year-ago predetermined period of time corresponding to the predetermined period of time of the target year, and
predicts the amount of usage of the output device for the predetermined period of time of the target year as being equal to the calculated amount of usage of the output device for the-year ago predetermined period of time.

2. The information processing apparatus of claim 1,
wherein, in predicting, the circuitry obtains a regression function based on an actual usage record of the output device for another predetermined period of time that is longer than the year-ago predetermined period of time, and
selectively uses an amount of usage based on the regression function or the calculated amount of usage for the year-ago predetermined period of time, as the predicted amount of usage.

3. The information processing apparatus of claim 1, wherein the circuitry predicts the amount of usage of the output device for the predetermined period of time of the target year based on a combination of the calculated amount of usage of the output device for the year-ago predetermined period and the regression function.

4. The information processing apparatus of claim 1, wherein the information relating to the actual usage record of the output device is a counter value that increases in accordance with usage of the output device, and
the circuitry predicts a total amount of usage of the output device in the customer environment based on the counter value.

5. The information processing apparatus of claim 1, wherein the information relating to the actual usage record of the output device is a plurality of counter values corresponding to a plurality of functions of the output device, each counter value increasing in accordance with usage of the corresponding function of the output device, and
the circuitry predicts the amount of usage of the output device in the customer environment for each of the plurality of functions of the output device based on the plurality of counter values.

6. The information processing apparatus of claim 1, wherein the information relating to the actual usage record of the output device is a plurality of counter values corresponding to a plurality of paper sizes, each counter value increasing in accordance with usage of a print function of the output device, and
the circuitry predicts the amount of usage of the output device in the customer environment for each of the plurality of paper sizes based on the plurality of counter values.

7. The information processing apparatus of claim 1, wherein the information relating to the actual usage record of the output device is a plurality of counter values corresponding to a color output and a monochrome output, each counter value increasing in accordance with usage of a print function of the output device, and
the circuitry predicts the amount of usage of the output device in the customer environment for each of the color output and the monochrome output based on the plurality of counter values.

8. The information processing apparatus of claim 1, wherein the information relating to the actual usage record of the output device is a plurality of counter values corresponding to a plurality of editing functions and a plurality of finishing functions of the output device, each counter value increasing in accordance with usage of the corresponding editing function or finishing function of the output device, and
the circuitry predicts the amount of usage of the output device in the customer environment for each of the plurality of editing functions and the plurality of finishing functions based on the plurality of counter values.

9. The information processing apparatus of claim 1, wherein the circuitry is further configured to generate screen data to be displayed at a client terminal, the screen data including a result of the predication of the amount of usage of the output device in the customer environment.

10. A method of predicting an amount of usage of an output device in a customer environment performed by an information processing apparatus, the method comprising:
acquiring information relating to an actual usage record of the output device in the customer environment; and
predicting an amount of usage of the output device for a predetermined period of time of a target year based on the acquired information,
wherein, the predicting calculates an amount of usage of the output device for a year-ago predetermined period of time corresponding to the predetermined period of time of the target year, and
predicts the amount of usage of the output device for the predetermined period of time of the target year as being equal to the calculated amount of usage of the output device for the-year ago predetermined period of time.

11. The method of claim 10, wherein the predicting obtains a regression function based on an actual usage record of the output device for another predetermined period of time that is longer than the year-ago predetermined period of time, and
selectively uses an amount of usage based on the regression function or the calculated amount of usage for the year-ago predetermined period of time, as the predicted amount of usage.

12. The method of claim 10, wherein the predicting the amount of usage of the output device for the predetermined period of time of the target year is performed based on a combination of the calculated amount of usage of the output device for the year-ago predetermined period and the regression function.

13. The method of claim 10, wherein the information relating to the actual usage record of the output device is a counter value that increases in accordance with usage of the output device, and
the predicting is predicting a total amount of usage of the output device in the customer environment based on the counter value.

14. The method of claim 10, wherein the information relating to the actual usage record of the output device is a plurality of counter values corresponding to a plurality of functions of the output device, each counter value increasing in accordance with usage of the corresponding function of the output device, and
the predicting is predicting the amount of usage of the output device in the customer environment for each of the plurality of functions of the output device based on the plurality of counter values.

15. The method of claim 10, wherein the information relating to the actual usage record of the output device is a plurality of counter values corresponding to a plurality of paper sizes, each counter value increasing in accordance with usage of a print function of the output device, and
the predicting is predicting the amount of usage of the output device in the customer environment for each of the plurality of paper sizes based on the plurality of counter values.

16. The method of claim 10, wherein the information relating to the actual usage record of the output device is a plurality of counter values corresponding to a color output and a monochrome output, each counter value increasing in accordance with usage of a print function of the output device, and
the predicting is predicting the amount of usage of the output device in the customer environment for each of the color output and the monochrome output based on the plurality of counter values.

17. The method of claim 10, wherein the information relating to the actual usage record of the output device is a plurality of counter values corresponding to a plurality of editing functions and a plurality of finishing functions of the output device, each counter value increasing in accordance with usage of the corresponding editing function or finishing function of the output device, and
the predicting is predicting the amount of usage of the output device in the customer environment for each of the plurality of editing functions and the plurality of finishing functions based on the plurality of counter values.

18. The method of claim 10, further comprising generating screen data based on which a result of the predication of the amount of usage of the output device in the customer environment is displayed at a client terminal.

19. An information processing system comprising:
circuitry to:
acquire information relating to an actual usage record of an output device in a customer environment; and
predict an amount of usage of the output device for a predetermined period of time of a target year based on the acquired information,
wherein, in the predicting, the circuitry calculates an amount of usage of the output device for a year-ago predetermined period of time corresponding to the predetermined period of time of the target year, and
predicts the amount of usage of the output device for the predetermined period of time of the target year as being equal to the calculated amount of usage of the output device for the-year ago predetermined period of time.
